(19) United States
(12) Patent Application Publication
(10) Pub. No.: US 2016/0014787 A1
(43) Pub. Date: Jan. 14, 2016

(54) System and Method for Information Centric Network Resource Allocation

(71) Applicant: Huawei Technologies Co., Ltd., Shenzhen (CN)

(72) Inventors: Hang Zhang, Nepean (CA); Xu Li, Nepean (CA)

(21) Appl. No.: 14/796,475

(22) Filed: Jul. 10, 2015

Related U.S. Application Data
(60) Provisional application No. 62/022,974, filed on Jul. 10, 2014.

(51) Int. Cl. H04W 72/04; H04W 8/20; H04W 4/00; H04W 28/20

(52) U.S. Cl. CPC H04W 72/0493; H04W 28/20; H04W 8/20; H04W 4/005

(57) ABSTRACT

A method includes receiving, by a software defined topology (SDT) controller from a first virtual gateway of a plurality of virtual gateways in a data plane, a report and updating customer specific service parameters in accordance with the report. The method also includes updating a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

This application claims the benefit of U.S. Provisional Application Ser. No. 62/022,974 filed on Jul. 10, 2014, and entitled “System and Method for an Information-Centric Machine-to-Machine Communications Network,” which application is hereby incorporated herein by reference.

### TECHNICAL FIELD

The present invention relates to a system and method for wireless communications, and, in particular, to a system and method for dynamically allocating resources which may support a just in time expandability for the management of machine-to-machine communication.

### BACKGROUND

Machine-to-Machine (M2M) networks provide long-term monitoring and control services, for example for traffic monitoring, fleet management, smart metering, environmental monitoring, industrial monitoring and control, and other applications. In some models, M2M traffic is dominated by a star-like uplink communication pattern, where a large number of machines (traffic sources) report to a few traffic sinks.

M2M communication may occur in different modes, such as pull mode and push mode. In pull mode, the sink nodes (M2M Application Servers) query M2M devices connected to the network for relevant information. Upon being queried, M2M devices reactively respond and where possible provide the requested data. On the other hand, in push mode, M2M devices proactively transmit data to the sink nodes. Push mode transmissions may be time-driven or event-driven.

M2M messages may be treated as independent messages. Information carried by messages is extracted by M2M customer application servers. The customer may indicate to an M2M Application Server associated with an M2M device to perform an action based on the extracted information. It is desirable for information processing to occur close to the network edge to reduce the reaction time.

### SUMMARY

An embodiment method includes receiving, by a software defined topology (SDT) controller from a first virtual gateway of a plurality of virtual gateways in a data plane, a report and updating customer specific service parameters in accordance with the report. The method also includes updating a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

An embodiment software defined topology (SDT) controller includes a processor and a non-transitory computer readable storage medium storing programming for execution by the processor. The programming includes instructions to receive, from a first virtual gateway in a plurality of virtual gateways in a data plane, a report and update customer specific service parameters in accordance with the report. The programming also includes instructions to update a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

An embodiment computer program product includes a non-transitory computer readable storage medium storing programming for execution by the processor. The programming including instructions for receiving, by a software defined topology (SDT) controller from a first virtual gateway of a plurality of virtual gateways in a data plane, a report and updating customer specific service parameters in accordance with the report. The programming also includes instructions for updating a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an embodiment information-centric machine-to-machine (M2M) network architecture;

FIG. 2 illustrates an embodiment system for information-centric M2M;

FIG. 3 illustrates another embodiment system for information-centric M2M;

FIG. 4 illustrates an additional embodiment system for information-centric M2M;

FIG. 5 illustrates a flowchart for an embodiment method of information-centric M2M performed by a software defined topology (SDT) controller;

FIG. 6 illustrates a flowchart of an embodiment method of interfacing with a wireless node operator performed by an M2M customer;

FIG. 7 illustrates a flowchart of an embodiment method of closed loop control with the M2M customer in the loop;

FIG. 8 illustrates a flowchart of an embodiment method of closed loop control where an M2M customer is notified of network changes;

FIG. 9 illustrates a flowchart of an embodiment method of M2M performed by a node;

FIG. 10 illustrates a block diagram of an embodiment processing system; and

FIG. 11 illustrates a block diagram of an embodiment a transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or not. The disclosure should in no way be limited to the illustrative implementations, drawings, and techniques illustrated below, including the exemplary designs and implementations illustrated and described herein, but may be modified within the scope of the appended claims along with their full scope of equivalents.

The advent of cloud-based networking has affected the ability of wireless networks to satisfy expected demands for higher throughput, lower processing latencies, lower energy consumption, and lower costs. In cloud based networking, the network can be nimble, flexible, and scalable. Thus, technologies such as network function virtualization (NFV) and software defined networking (SDN) can be used in building wireless networks. NFV facilitates network functions which are traditionally tied to hardware to run on a cloud computing infrastructure in a data center. SDN techniques allow for the separation of the data plane, control plane, and the management plane. The separation of these network functions from the hardware infrastructure is used in wireless network architecture.

Application layer in-network processing is used in machine-to-machine (M2M) communications, or machine type communications (MTC), to reduce energy and bandwidth consumption. Raw machine data from logical nodes is gathered and aggregated or processed on its way to sink nodes. A logical node is a software defined entity implemented at a physical network node which can assume a variety of roles and perform a variety of functions, such as a user-specific virtual serving gateway (v-u-SGW), a v-s-SGW, or a content container. The data aggregation occurs at individual intermediate nodes or at pre-defined aggregation points. The data aggregation function may be pre-determined and fixed.

A service provider or application provider may collect information from M2M devices. For example, billing information may be collected, for example from an electrical meter, a gas meter, a water meter, or another meter, where the meters report usage. In another example seismic sensors are deployed in the field to measure earthquakes. It may be desirable to stagger the data reporting for scheduled reporting from M2M devices, so the network is not overwhelmed with congestion, for example from event driven reporting. Congestion may be especially problematic when a triggering event, such as an emergency, occurs.

It is desirable to improve response time in an M2M network by reducing latency. Moving processing capability close to the network edge may reduce latency, because it allows processing of traffic to be performed near the network edge. By processing data at or near the network edge, the amount of data traversing the network is reduced, and the overall latency associated with the processing of the traffic can be reduced. A network provider may offer different levels of latency, where billing is based on the latency. For example, some users may pay more for lower latency, while other uses may pay less and have a higher latency.

In some situations, many M2M devices may attempt to report data at the same time. In the case of metering devices, this can easily be remedied by having the devices stagger their reporting times. However, devices with event driven reporting cannot be dealt with in a similar fashion. For example, seismic sensors deployed in the field usually report nothing. When a single, typically small and very short, earthquake occurs, the sensors closest to the event sense the earthquake and report the data. However, larger earthquakes are typically a series of seismic events and may extend over a longer time period. When a large earthquake occurs, many more sensors will detect the tremor, and they will likely detect more events over a longer period of time. As such, there will be an increased number of transmissions from a larger number of sensors. It is desirable to report the data in a timely manner without overwhelming the network. Processing the data near the edge before transmission across the entire network may be useful to reduce traffic. An increase in the data rate or the packet arrival rate may be detected and used to modify data transmission pathways in the network. For example, when there is an increase in traffic, scheduled reporting may be suspended until the increase subsides. The number of messages being transmitted, the amount of data per message, and/or the aggregate data may be useful in determining whether the network is being overloaded.

In an embodiment, processing is performed at edge nodes, and the base station (BS) or a data center which is hosting the instantiation of the base station control functions can perform some message processing. An edge node may be a base station or other node located near the edge of the network.

An M2M service provider may have its processing services hosted in a data center such as a distributed data center provided by the telecommunication service provider.

Software defined topology may be used in M2M networks. The location of a virtual machine, either in the context of the topology of the network or in the context of the location of the physical nodes on which the virtual machine is instantiated, may be determined by a logical node. A virtual machine may be an instantiation of a computing node atop an existing infrastructure. A virtual node may be specific to the customer. Also, a virtual network with an M2M customer may contain devices and provide network resources which provide services for the devices. A mechanism may be included to adapt to unexpected situations. For example, the network may detect and inform customers of unexpected changes. In another example, the network detects and automatically implements changes to the network (either in terms of the topology of the network or to the functionality of nodes in the network) based on the performance of the network. A virtual network may use physical infrastructure and have components such as a gateway and application layer functions.

In an information-centric approach to networking, gateways are used by customers to receive M2M messages. In one example, the network is a virtual network with a virtual gateway and virtual functions which provides a fast response. Data from M2M devices may be used to make decisions on the topology of the network. M2M data may be transmitted over the virtual network. Also, the virtual network topology may be based on customer requirements.

SDN is an architectural framework for creating intelligent programmable networks. It allows for decoupling of the control and data planes. In a software defined network, logical network functions and nodes are built atop an underlying network infrastructure, so that the infrastructure can be hidden from the users of the virtual network. The control plane may use customer requirements and network provider resources to form a service-customized logical network topology created by a software defined topology (SDT) controller. An SDT controller cooperates with an SDN controller to facilitate traffic control/processing by placing virtual gateways and creating a virtual backbone between virtual gateways by the SDT controller. Virtual gateways can be defined on a per-service basis, where a service may have multiple virtual gateways. The virtual gateways of multiple services may be physically co-located. For M2M services, virtual gateways may be per-service specific gateways, which are referred to as virtual per-service specific serving gateways (v-s-SGWs), or per-UE gateways. M2M traffic is gathered at v-s-SGWs and forwarded to the final destination(s) over a virtual backbone topology. The SDT controller provides a customized topology over a physical infrastructure that allows for information delivery, and enables on-demand and service specific data plane architectures. For each application, service, or virtual network (VN), the SDT controller may determine an on-demand and customized data plane logical topology. The SDT controller determines the placement of logical network nodes and functions in the data plane in physical nodes in the underlying network architecture. The SDT controller may also define the topology of the nodes in the data plane logical topology. Additionally, the SDT controller defines service-specific functionalities for logical nodes in the data plane logical topology. The SDT controller determines the data plane logical topology for the application, service, or VN in accordance with requirements from the operators or customers. The SDT controller also determines the data plane logical topology in accordance with the service-customized logical network topology, service traffic characteristics, customer distribution, mobility speed predictions, and traffic load predictions. The SDT controller facilitates the adaptability of data plane logical topology to changes in traffic load and traffic load predictions, network node capabilities, and mobility of customer devices. Additional details on SDT are discussed in U.S. patent application Ser. No. 14/297,269, entitled “System and Method for Mapping a Service-Level Topology to a Service-Specific Data Plane Logical Topology,” filed on Jun. 5, 2014, which is hereby incorporated herein by reference.

In an embodiment, an SDT is combined with software defined protocol (SDP) to create a customized virtual network. A virtual network is a collection of resources virtualized for a particular service. An SDP protocol provides a way of customizing the manner in which individual network nodes process traffic in the network. Also, an SDP defines the functions to be utilized, and coordinates packet transmissions. Additionally, an SDP defines the order in which packets are processed, for example either in parallel or sequentially. In an SDP controller protocols may be implemented in software, new protocols may be installed on the network node, and the protocols may be changed or upgraded without replacing the network node. Additional details on SDP are included in U.S. patent application Ser. No. 13/952,489, entitled “System and Method for Providing a Software Defined Protocol Stack,” filed on Jul. 26, 2013, and U.S. patent application Ser. No. 14/160,146, entitled “System and Method for a Software Defined Protocol Network Node,” filed on Jan. 21, 2014, both of which are hereby incorporated herein by reference.

An embodiment system and method for an information-centric communications network provides a service-customized information-centric M2M network architecture. An embodiment includes a mechanism for customizing customer specific local data processors/analyzers, such as v-s-SGWs having a customized dynamic per-service in-network processing. The mechanism may include interactions between an SDP controller and the customer or network operation, between an SDP controller and an SDT controller, and between an SDP controller and the data plane.

In an embodiment, a network is based on customer requirements, including exception processing rules. The topology is defined, reported to the customer, and nodes, such as v-s-SGWs, are instantiated. Different nodes may perform different actions. Processing is performed by the nodes relatively close to the devices, facilitating quick responses. Also, a node may quickly identify exceptions and report them to the customer or the SDP controller. The traffic load may be reduced by quickly responding to exceptions. The customer may pay for network processing to reduce payments for network traffic. Some processing on traffic generated by M2M devices is performed in the network by virtual machines (VMs) on behalf of the M2M customer.

With service-specific application-layer functions installed, nodes process received M2M service traffic and may transmit the processed data, rather than the raw data, to traffic sinks. In other examples, the nodes analyze the received data, detect service exceptions, and transmit control commands to relevant machines upon detection. The volume of data to be transmitted may change after data processing, depending on the processing functions. For data aggregation or filtering functions, such as computing the average or determining the maximum temperature in an environmental monitoring application, data volume decreases after processes. For functions such as some forms of encryption, data volumes increase after processing. In-network data processing may occur in both push and pull modes.

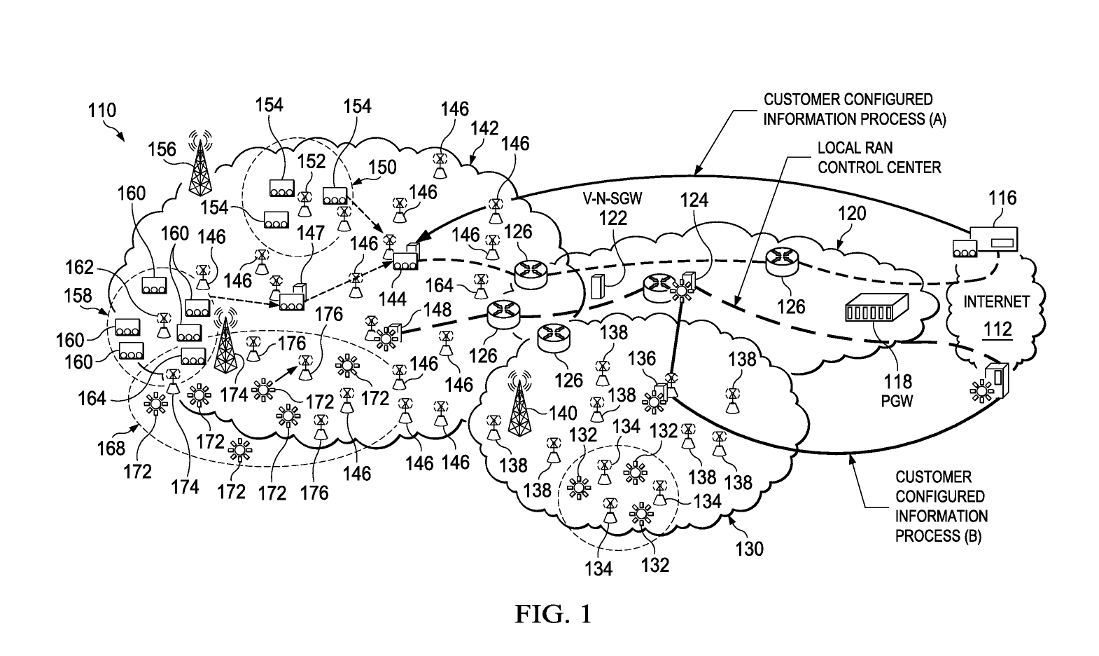

FIG. 1 illustrates network 110, which supports an information-centric customized virtual network architecture supporting M2M transactions. Processing, such as monitoring and aggregation, may be performed close to the network edge in logical nodes or nodes which are configured to process application layer data, which is customized to the M2M service. There are two M2M customers in network architecture 110, M2M service 116 for customer A, a health service, for example emergency service to provide first aid, and M2M service 114 for customer B, a temporary service. In other examples, more or fewer customers may be present in a network. Different services for different customers may be co-located.

Public data network (PDN) gateway (PGW) 118 provides an interface between internet 112 and network 120. Network 120 contains virtual network serving gateway (v-n-SGW) 122. The v-n-SGW is a common virtual serving gateway shared by all services. Also, network 120 contains service-specific v-s-SGW 124 and serving gateways 126.

A customer configured process which is custom configured for customer B is performed in service node 136 in customer B region 128. Customer B network devices 138 and base station 140 processes customer B information. For example, area 130 contains customer B network devices 134 and customer B M2M devices 132.

Region 142 contains processing for both customer A and customer B. Customer A processing center 144 performs processing for customer A, for example by filtering on the application layer. Region 142 also contains customer A network devices 146. Processing center 144 in region 142 communicates with M2M service 116, processing center 147, and region 150. Processing center 147 performs similar processing, and communicates with region 158. Regions 150 and 158 are customer A regions which contain customer A network devices 152 and 162, and customer A M2M devices 154 and 160. Also, base station 156 provides coverage in region 142. Region 142 also contains customer B processing center 148, which performs processing, such as location information of reporters or the amount of reporting information in the application layer. Customer B processing center 148 interfaces with region 168, which contains customer B M2M devices 172. There is some overlap between region 168 and region 158. Region 168 contains base station 174, customer B network devices 176, and customer B M2M devices 172.

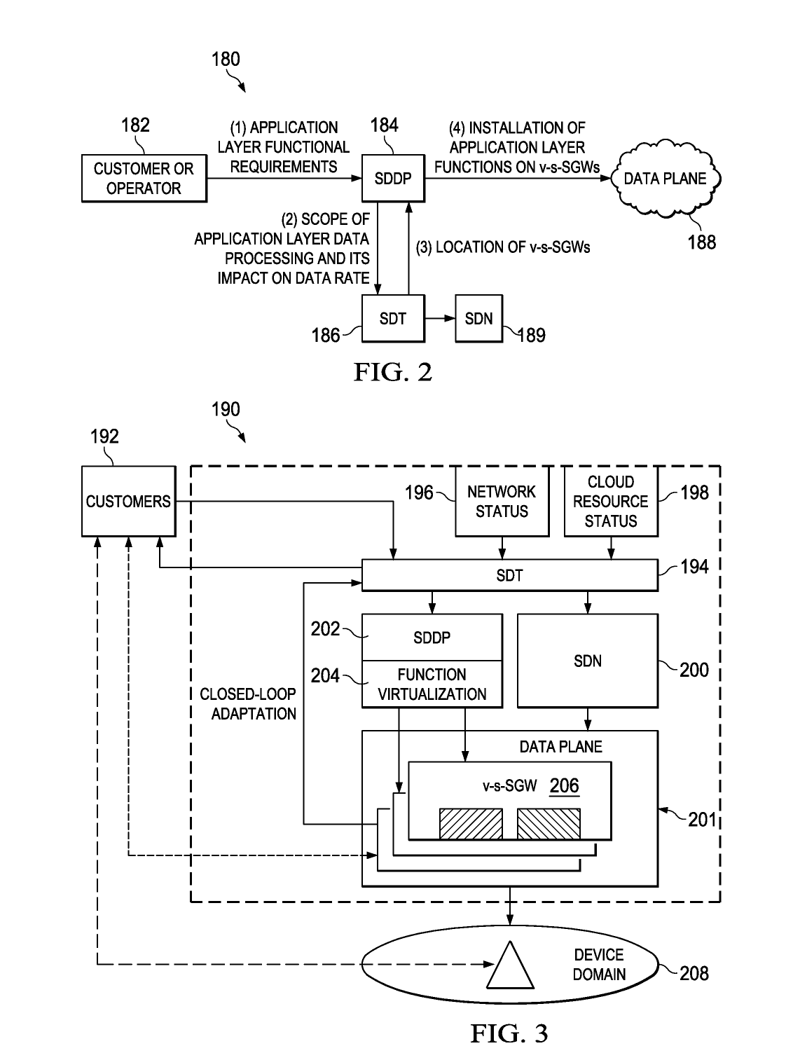

FIG. 2 illustrates system 180 for functional customization. M2M customer 182 specifies application layer functional requirements to software defined data process (SDDP) controller 184, which facilitates customization of processing capabilities of individual network nodes to the traffic in the network. SDDP controller 184 defines the functions to be engaged. Also, SDDP controller 184 defines the order in which packets are processed, for example either in parallel or sequentially. Additionally, SDDP controller 184 determines which application layer functions will be applied, and where to apply them (e.g., geo-regions, machine sets, etc.).

SDDP controller 184 notifies SDT controller 186 of the scope of the applied application layer functions and their overall impact on the data rate. The data rate impact may be described, for example by using a rate reduction function or a rate based on the input and other data.

SDT 186 controller determines the locations of nodes, such as v-s-SGWs, based on the information from SDDP controller 184. Then, SDT controller 186 indicates the location of the nodes to SDDP controller 184.

Next, SDDP controller 184 installs application layer functions on nodes in data plane 188. The installation is based on the location information received from SDT controller 186.

Also, SDN controller 189 receives signaling from SDT controller 186 which indicates the location of the virtual functions. SDN controller 189 then manages the instantiation of the virtual functions.

When node selection/definition changes or the application layer function requirements change, SDDP controller 184 updates the data plane by installing or uninstalling application layer functions on the relevant nodes.

FIG. 3 illustrates system 190 for information centric VN creation. Customers 192 are Internet of Things (IoT) or M2M service customers. The customers interact with the virtual network. Initially, customers 192 provide a service description and/or service requirement update to SDT controller 194. For example, the customer may request an update when an earthquake occurs. The service description may include the device distribution and traffic behavior characteristics or schedule. The service requirement may include data analysis, event definition, reaction definition, and reaction latency to an event.

SDT controller 194 is aware of network status 196, for example capacity statistics, and cloud resource status 198, including in-network status and in-data center (DC) status. SDT controller 194 accepts the requests from customers 192 and determines logical function definition and service-customized logical network topology based on the network status, cloud resource status, and service description. The service-customized logical network topology is transmitted to SDN controller 200, which may be a software defined radio access network (SDRAN), and the data plane logical topology and logical function definition (e.g. v-s-SGW) is transmitted to SDDP controller 202. Also, the v-s-SGW information or update, for example the network address and device message transmission schedule are determined and transmitted to customers 192. The location of the function may also be determined.

SDDP controller 202, a service/software defined data process, interacts with function virtualization module 204. Function virtualization module 204 creates multiple instances of v-s-SGWs 206 customized to the customer needs. The software protocol is provided to the physical node from SDDP controller 202.

SDN controller 200 sets up logical links in the data plane. This involves logical provisioning so the traffic goes on the appropriate physical path. Also, SDN controller 200 provides provisioning to data plane 201, which may include network nodes, a data center, and v-s-SGWs 206.

Customers 192 communicate with v-s-SGW 206 and device domain 208. Control plane communication occurs between the customer and v-s-SGW, including data analysis, event definition, and reaction definition. The customer 192 may configure the data process or analysis in the v-s-SGW 206. The customer 192 transmits to the v-s-SGW 206 the data process/analysis, the event or event type definition, the reaction definition per event of the event type, including the M2M control reaction and the SDT adaptation reaction. The v-s-SGW 206 transmits event based data to the customer events as they are reported from the device domain 208. The v-s-SGWs are multiple logical nodes which provide multiple functions for multiple services. Also, there is a message transmission schedule or update communications between the customer and the device domain. This may be a recommended schedule, which is optional. The device domain transmits a recommended schedule to the customer, which decides whether or not to follow the recommended schedule. The customer responds indicating whether it accepts the proposed schedule.

Finally, the v-s-SGW 206 communicates with device domain 208 by updating the transmission schedule.

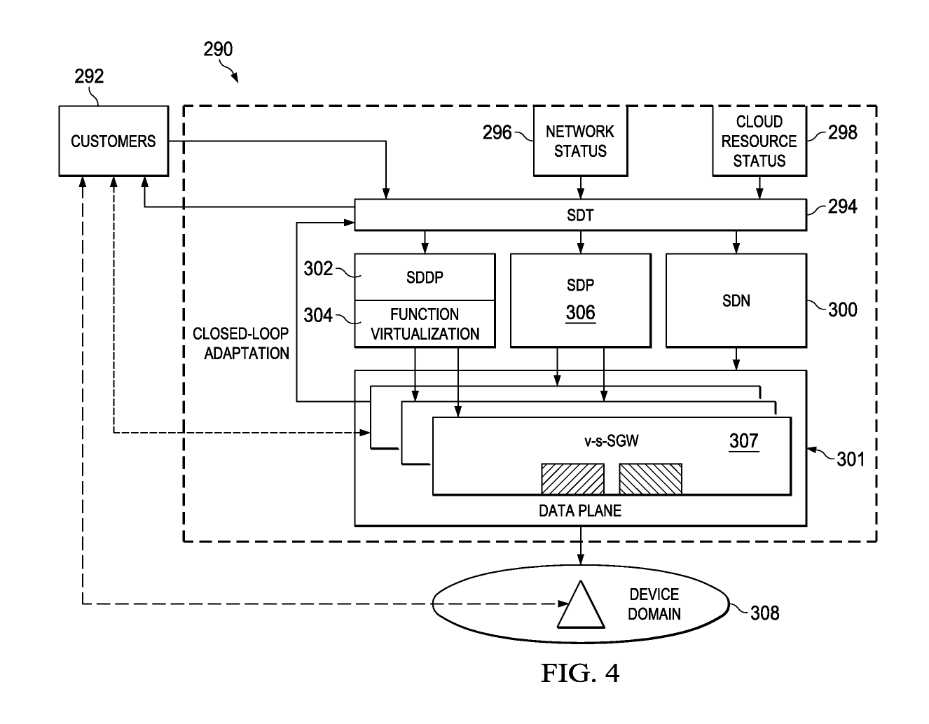

FIG. 4 illustrates system 290 for information centric VN creation. Customers 292 are IoT or M2M service customers. The customers 292 interact with the virtual network for network customization. Initially, customers 292 provide a service description and/or service requirement update to SDT controller 294. For example, the customer may request an update when an earthquake occurs. A service description may include the device distribution and traffic behavior characteristics or a schedule, while the service requirement may include data analysis, event definition, reaction definition, and reaction latency to an event.

SDT controller 294 is aware of network status 296, for example capacity statistics of the network, and cloud resource status 298, including the in-network status and the in-DC status. SDT controller 294 receives requests from customers 292 and determines logical function definition and service-customized logical network topology based on the network status, cloud resource status, and service description. The service-customized logical network topology is transmitted to SDN controller 300, which may be a SDRAN, and the data plane logical topology, while the logical function definition (e.g. v-s-SGW) is transmitted to SDP controller 306. Also, the node information or update, for example the network address and device message transmission schedule, are determined by SDT controller 294 and transmitted to customers 292. The location of the function may also be determined by SDT controller 294.

SDP controller 306 receives the data plane logical topology from SDT controller 294. Also, SDP controller 306 determines the data plane transport protocol for each logical link in the topology based on the data plane logical topology. Additionally, SDP controller 306 instantiates the customized protocol in the data plane for the service.

SDDP controller 302 interacts with function virtualization module 304. Function virtualization module 304 creates multiple instances of v-s-SGWs 307 customized to the customer. SDDP controller 302 receives the data plane logical topology and logical function definition from SDT controller 294.

SDN controller 300 sets up physical links in the data plane. For example, logical provisioning is performed to direct traffic along the appropriate physical path. Also, SDN controller 300 provides provisioning to data plane 301, which may include network nodes, a data center, and v-s-SGWs 307.

Customers 292 communicate with v-s-SGW 307 and device domain 308. Control plane communication occurs between the customers 292 and v-s-SGW 307, including data analysis, event definition, and reaction definition. The customers 292 may configure the data process or analysis in the v-s-SGW in accordance with the customer's needs. The customers 292 transmit to the v-s-SGW the data process/analysis, the event or event type definition, the reaction definition per event of the event type, including the M2M control reaction, and/or the SDT adaptation reaction. The v-s-SGW 307 transmits to the customers 292 information about events as they occur. The v-s-SGWs are multiple logical nodes which provide a variety of functions for multiple services. Also, there is transmission from the v-s-SGW 307 to the customer 292 of a schedule or updated communications between the customers 292 and the device domain 308. The schedule may be an optional schedule. The device domain transmits a recommended schedule (e.g., a schedule recommended by the network) to the customer 292. The customer 292 decides whether or not to follow the recommended schedule. The customer 292 responds to the v-s-SGW 307 indicating whether it accepts the recommended schedule.

Finally, the v-s-SGW communicates with device domain 308 to update the actual transmission schedule.

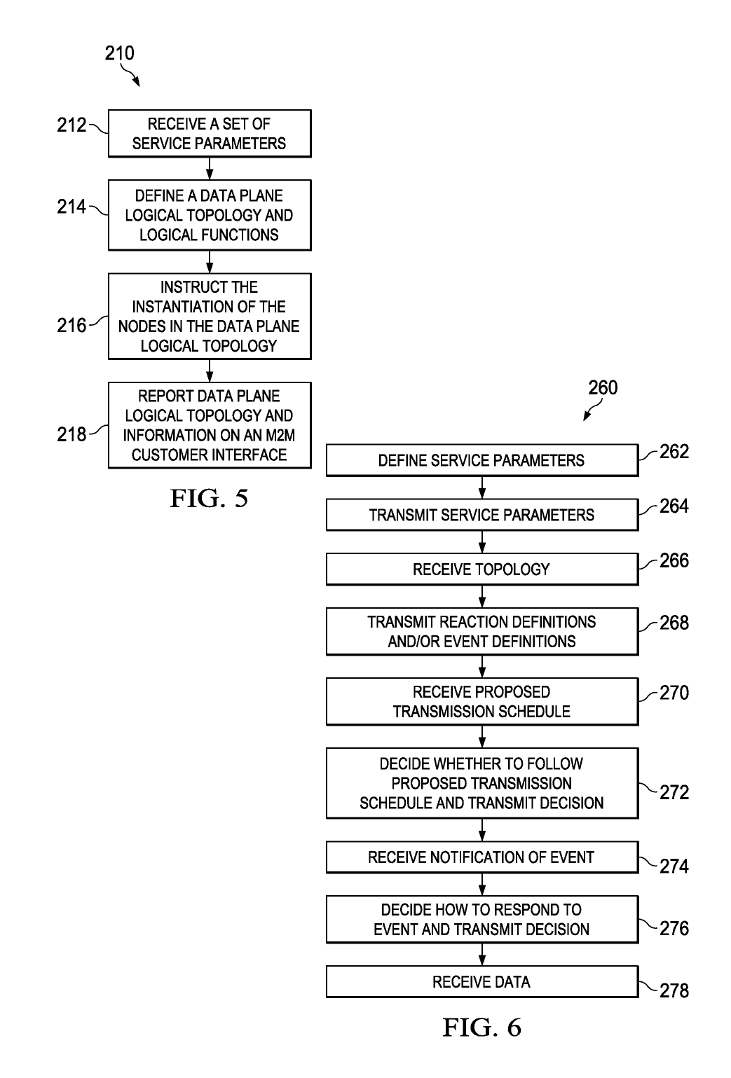

FIG. 5 illustrates flowchart 210 for a method of instantiating logical nodes, such as v-s-SGWs, based on customer requirements, as may be performed by an SDT controller. Initially, in step 212, the SDT controller receives, from M2M customers, a set of service parameters, such as service descriptions and service requirements, which define actions to be taken by network nodes. The service descriptions may include service/application characteristics, consumer equipment behavior, traffic statistics, and application-layer data processes or virtual functions to be instantiated in a network for the service, and descriptions and properties, such as a traffic rate reduction factor. Service requirements may include quality of experience (QoE) requirements, quality of service (QoS) requirements, and content requirements. User equipment behavior may include parameters such as mobility, location, and geographic distribution for user equipments. Additionally, traffic statistics may include network capability, traffic load, and network congestion. Actions to be taken by the network may include triggering the SDT controller, under specific conditions, to adapt by creating new virtual functions of the same type or of a different type, migrating existing virtual functions, terminating an existing virtual function, or taking another action.

Next, in step 214, the SDT controller defines a data plane logical topology, including locations for logical nodes and logical functions to be carried out at the logical nodes. The data plane logical topology may be implemented in accordance with the service parameters received in step 212.

Then, in step 216, the SDT controller instructs the instantiation of the nodes in the data plane logical topology in accordance with the defined topology locations and the logical functions. The SDT controller may also transmit the data plane logical topology to the SDN controller.

Finally, in step 218, the SDT controller reports the data plane logical topology to the customer. Also, the SDT controller transmits information from the customer to instantiated nodes.

Interactions between the logical node and the customer may be closed loop or open loop (customer in the loop). Having the customer in the loop improves customer control, but may introduce a significant lag time, which may be problematic when decisions need to be made promptly.

FIG. 6 illustrates flowchart 260 for a method of customer interaction performed by a customer. Initially, in step 262, the customer determines service parameters and transmits the service parameters to the logical node. The service parameters may include service descriptions and service requirements, which define actions to be taken by logical nodes when particular events occur. The service descriptions may include service/application characteristics, user equipment behavior, traffic statistics, application-layer data processes or virtual functions to be instantiated in the network, and respective descriptions and properties of the service descriptions. Service requirements may include QoE requirements, QoS requirements, and content requirements. User equipment behavior includes parameters such as mobility, location, and geographic distribution of user equipments. Additionally, traffic statistics include network capability, traffic load, and network congestion. Actions to be taken may include triggering the SDT controller, under specific conditions, to adapt by creating new virtual functions of the same type or of a different type, migrating existing virtual functions, terminating an existing virtual function, or taking another action.

Next, in step 264, the customer transmits the service parameters to the SDT controller.

Then, in step 266, the customer receives a data plane logical topology from the SDT controller. The data plane logical topology has been determined according to the service parameters by the SDT controller. The data plane logical topology may include locations for logical nodes, such as v-s-SGWs, and logical functions to be carried out at logical nodes.

In step 268, the customer transmits to the logical node configuration content for data processes on the logical node, for example reaction definitions and/or event definitions. In another example, the reaction definitions and/or event definition are part of the service parameters provided by the customer to the network. The customer may update the service parameters at runtime to reflect changes in the business logic. The customer re-configures or updates the configuration of one or more virtual functions instantiated on the logical nodes. Reaction definitions and/or event definitions are examples of configuration content. The event definitions indicate events to which the logical nodes should react, and the reaction definitions indicate the reactions of a logical node when an event it detected. Step 268 may be performed when an update occurs. In some examples, step 268 is not performed.

The customer receives a proposed transmission schedule from the logical node in step 270. The proposed transmission schedule may be determined in accordance with events which have occurred. In some examples, step 270 is not performed.

Next, in step 272, the customer decides whether to follow the proposed transmission schedule, and informs the logical node of the decision. In some examples, step 272 is not performed.

In step 274, the customer receives a notification of an event, for example from the SDT controller or from the logical node.

Next, in step 276, the customer decides how to respond to the event. The customer transmits the response to the SDT controller.

Finally, in step 278, the customer receives data from the logical node.

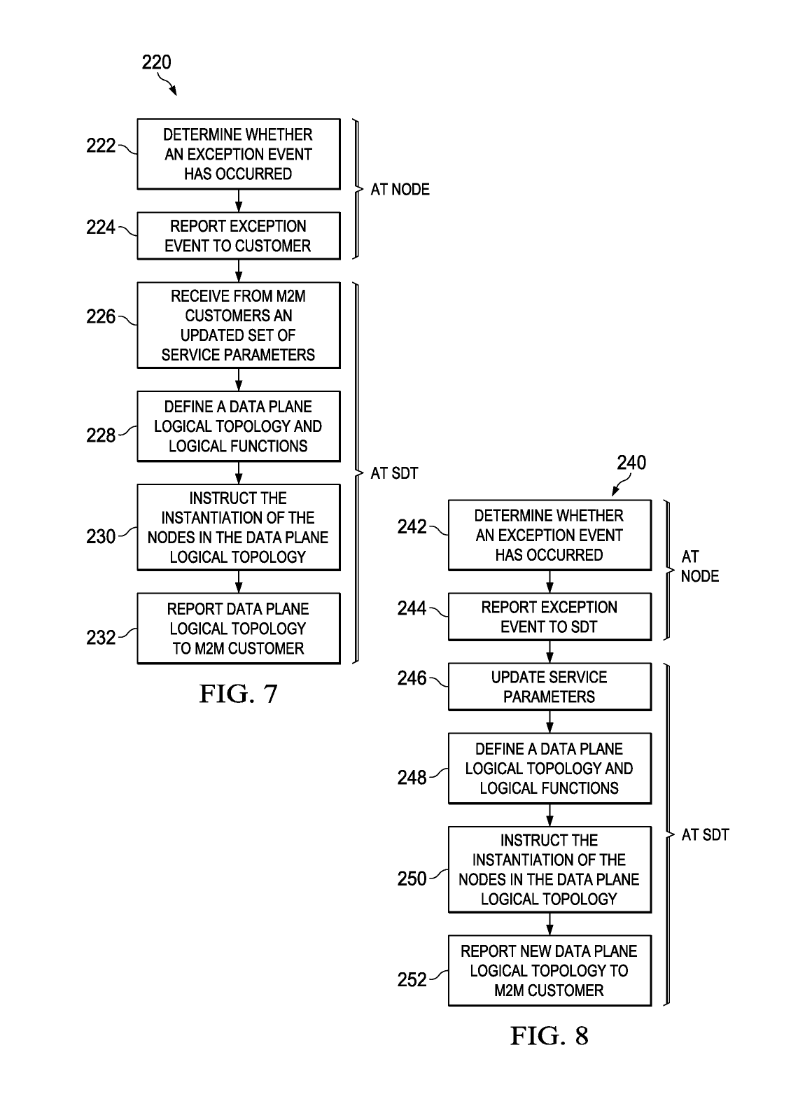

FIG. 7 illustrates flowchart 220 for a method of closed loop interaction with a customer at a logical node, such as a v-s-SGW, and at an SDT controller. Initially, in step 222, the logical node determines a definition of service expectations, for example based on customer definitions of service expectations. The logical node may determine whether an exception event has occurred. Examples of exception events include receiving too many reports in a given period time or receiving reported data which is outside of a defined range.

Next, in step 224, the logical node reports exception events to the customer. The customer decides how to respond to the exception event. Because the reaction rules have already been provided by the customer, the logical node may respond in real time to the exception event through an application-layer virtual function which is part of the service description, and instantiated by the network as requested by the customer. For example, a sprinkler may be activated upon detecting a fire. The SDP controller may change a virtual function in accordance with the exception report. For example, the SDP controller may instantiate, migrate, terminate, or re-configure a virtual function.

Then, in step 226, the SDT controller receives an updated set of service parameters from the customer. The service parameters may include service descriptions and service requirements defining actions to be taken by network nodes, including time limits for the updates. These updated service parameters indicate the response of the customer to the exception event.

In step 228, the SDT controller defines or updates a data plane logical topology, including locations for logical nodes and logical functions, to be carried out at logical nodes in the data plane logical topology, such as v-s-SGWs. Time limits for the changes may be included in the updates. The data plane logical topology is determined based on the service parameters received from the customer.

Next, in step 230, the SDT controller instructs the instantiation of the logical nodes in the data plane logical topology in accordance with the defined topology locations and the logical function determined in step 228.

Finally, in step 232, the SDT controller reports the data plane topology to the customer.

FIG. 8 illustrates flowchart 240 for an embodiment method where a customer is notified by the SDT controller of a network change. The customer is out of the control loop, but is notified of changes to the network. A closed-loop provides a virtual network with elastic virtual edges and edge processing for the M2M service which may be highly responsive to exceptions. The virtual edges are elastic edges because they may be instantiated, terminated, and migrated dynamically. Initially, in step 242, the logical node determines whether an exception event has occurred based on customer definition of service expectations. Examples of exception events include too many reports in a short period of time, receiving reported data out of a defined range, a traffic jam, or an emergency, such as an earthquake or wildfire.

Next, in step 244, the logical node reports the exception event to the SDT controller. The exception event may trigger the SDT controller to adapt according to the service parameters, for example by creating new virtual functions of the same type or of different types, migrating existing virtual functions, or terminating existing virtual functions.

Then, in step 246, the SDT controller updates service parameters in accordance with the exception report received in step 244. Updated service parameters may include service descriptions and service requirements defining actions to be taken by network nodes, including time limits for reactions.

In step 248, the SDT controller defines or updates the data plane logical topology, including locations for logical nodes and logical functions to be carried out at logical nodes in the data plane logical topology. The data plane logical topology is defined in accordance with the service parameters determined in step 246. The SDT controller may modify a virtual function in accordance with the exception report. The modification of the data plane logical topology may also include a modification to the capacity of an existing virtual gateway. In one example, if the process has been triggered by an increase of data traffic handled by a particular virtual gateway, the SDT may choose to increase the processing capacity or bandwidth allocated to the virtual gateway serving the nodes that are generating the increased traffic. This may be combined with a relocation of the virtual gateway so that it is better placed in the topology to serve the nodes generating the increased traffic (even possibly at the expense of being further away from other nodes generating less traffic).

Next, in step 250, the SDT controller instructs the instantiations of the logical nodes in the topology in accordance with the defined logical node locations and the logical function determined in step 248.

Finally, in step 252, the SDT controller reports the new data plane logical topology to the customer.

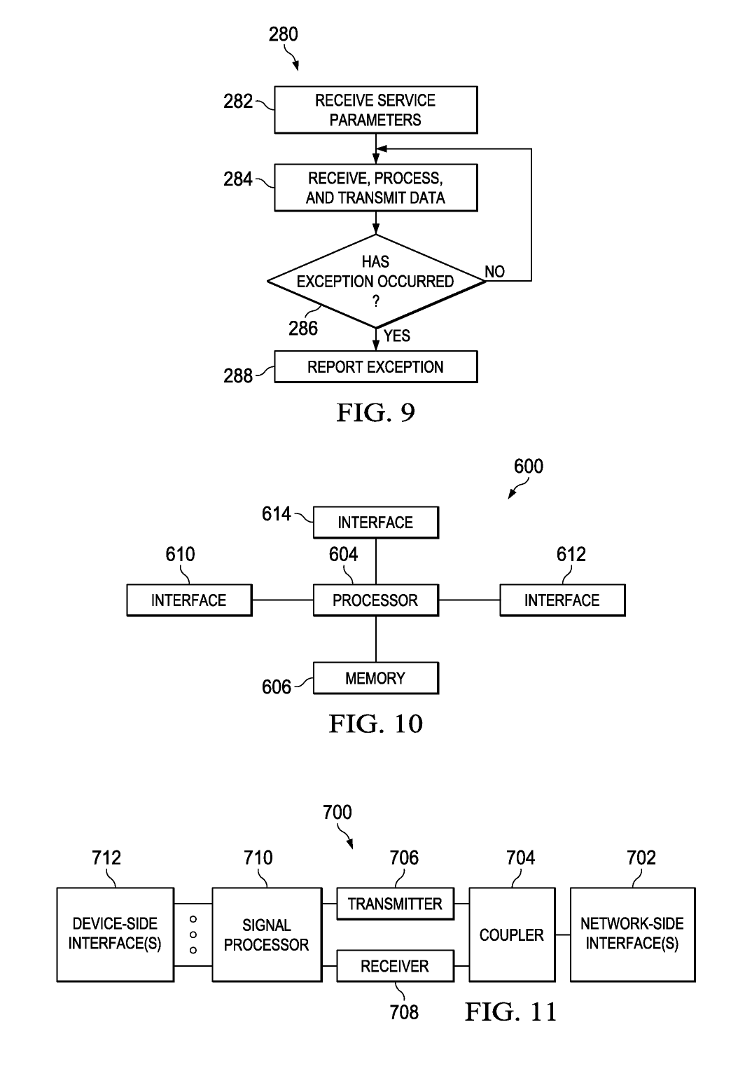

FIG. 9 illustrates flowchart 280 for an embodiment method of M2M communication performed by a logical node. The logical node may be a v-s-SGW or another logical node in the date plane logical topology defined for the customer. Initially, in step 282, the logical node receives service parameters from a customer. The service parameters include service descriptions and service requirements, which define actions to be taken by network nodes. The service descriptions may include service/application characteristics, user equipment behavior, and traffic statistics. Service requirements may include QoE requirements, QoS requirements, and content requirements. User equipment behavior includes parameters such as mobility, location, and geographic distribution. Additionally, traffic statistics include network capability, traffic load, and network congestion. Actions may include triggering the SDT controller, under specific conditions, to adapt by creating new virtual functions of the same type or of a different type, migrating existing virtual functions, terminating an existing virtual function, or taking another action.

Next, in step 284, the logical node receives, processes, and transmits data. The logical node receives data from M2M devices and processes this data. The processing may be based on the service parameters. Then, the logical node transmits the processed data to the customer. Also, the node may receive exception reports from the M2M device.

In step 286, the logical node determines whether an exception has occurred. When an exception has not occurred, the logical node proceeds to step 284 to continue to receive, process, and transmit data. When an exception has occurred, the logical node proceeds to step 288.

In step 288, the logical node reports the exception, for example to a customer and/or the SDT controller. The logical node may also take additional actions to interact dynamically with the physical world when an exception occurs in accordance with the service requirements. For example, the logical node may activate a sprinkler actuator when a wildfire is detected. In another example, the logical node causes a circuit to break when a voltage surge is detected in smart grid applications.

The logical node interfaces with edge nodes to inform the base station of events and reactions to events. Reactions and events which trigger reactions are defined by the customer. The logical node performs a control function which is defined by the customer. The control function includes local content analysis, message load changes, and application business logic adjustments. There is an interface between the logical node and the access network. A local reaction of the node is defined by the customer, and triggers SDT adaptation, such as virtual function (VF) creation, termination, and migration, and logical link definition. The triggering adaptation reflects the application's business logic dynamics and facilitates application performance. The local reaction is also based on the service treatment priority. Based on the application-specific analysis of reports received from one or more devices, the service-specific data processing entity, the node transmits instructions to the serving access points (APs) to mark packets received from the devices with a specified priority. This may, for example, be a differentiated services (DiffServ) code point (DSCP) inserted into an internet protocol (IP) packet header or a multiprotocol label switching (MPLS) label attached to the packet.

There is also an interface between the logical node and the devices. Reactions and events triggering a reaction are defined by the customer. The message transmission frequency and content to be reported are controlled by the logical node.

In one example, the standard procedure is to transmit information every hour six minutes after the hour. When there is notice of a triggering event, data is transmitted every ten minutes. For example, in an electrical meter, a trigger is increased usage and a high detected temperature, which triggers extra information being transmitted by the electrical meter.

In an embodiment, an M2M customer provides a description of services requested, leading to a change in the network topology. In an embodiment, a change in the network is in response to data or events. For example, changes to a sensor network may be initiated by information from the sensors. In one example, when there is a fire in the neighborhood, thermostats stop transmitted data to provide more bandwidth for emergency related devices.

FIG. 10 illustrates a block diagram of an embodiment processing system 600 for performing methods described herein, which may be installed in a host device. As shown, the processing system 600 includes a processor 604, a memory 606, and interfaces 610-614, which may (or may not) be arranged as shown in FIG. 10. The processor 604 may be any component or collection of components adapted to perform computations and/or other processing related tasks, and the memory 606 may be any component or collection of components adapted to store programming and/or instructions for execution by the processor 604. In an embodiment, the memory 606 includes a non-transitory computer readable medium. The interfaces 610, 612, 614 may be any component or collection of components that allow the processing system 600 to communicate with other devices/components and/or a user. For example, one or more of the interfaces 610, 612, 614 may be adapted to communicate data, control, or management messages from the processor 604 to applications installed on the host device and/or a remote device. As another example, one or more of the interfaces 610, 612, 614 may be adapted to allow a user or user device (e.g., personal computer (PC), etc.) to interact/communicate with the processing system 600. The processing system 600 may include additional components not depicted in FIG. 10, such as long term storage (e.g., non-volatile memory, etc.).

In some embodiments, the processing system 600 is included in a network device that is accessing, or part otherwise of, a telecommunications network. In one example, the processing system 600 is in a network-side device in a wireless or wireline telecommunications network, such as a base station, a relay station, a scheduler, a controller, a gateway, a router, an applications server, or any other device in the telecommunications network. In other embodiments, the processing system 600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 610, 612, 614 connects the processing system 600 to a transceiver adapted to transmit and receive signaling over the telecommunications network. FIG. 11 illustrates a block diagram of a transceiver 700 adapted to transmit and receive signaling over a telecommunications network. The transceiver 700 may be installed in a host device. As shown, the transceiver 700 comprises a network-side interface 702, a coupler 704, a transmitter 706, a receiver 708, a signal processor 710, and a device-side interface 712. The network-side interface 702 may include any component or collection of components adapted to transmit or receive signaling over a wireless or wireline telecommunications network. The coupler 704 may include any component or collection of components adapted to facilitate bi-directional communication over the network-side interface 702. The transmitter 706 may include any component or collection of components (e.g., up-converter, power amplifier, etc.) adapted to convert a baseband signal into a modulated carrier signal suitable for transmission over the network-side interface 702. The receiver 708 may include any component or collection of components (e.g., down-converter, low noise amplifier, etc.) adapted to convert a carrier signal received over the network-side interface 702 into a baseband signal. The signal processor 710 may include any component or collection of components adapted to convert a baseband signal into a data signal suitable for communication over the device-side interface(s) 712, or vice-versa. The device-side interface(s) 712 may include any component or collection of components adapted to communicate data-signals between the signal processor 710 and components within the host device (e.g., the processing system 600, local area network (LAN) ports, etc.).

The transceiver 700 may transmit and receive signaling over any type of communications medium. In some embodiments, the transceiver 700 transmits and receives signaling over a wireless medium. For example, the transceiver 700 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 702 comprises one or more antenna/radiating elements. For example, the network-side interface 702 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 700 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

An embodiment method includes receiving, by a software defined topology (SDT) controller from a first virtual gateway of a plurality of virtual gateways in a data plane, a report and updating customer specific service parameters in accordance with the report. The method also includes updating a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

In an embodiment method, adding the virtual gateway includes determining a location and capacity for an added virtual gateway in the data plane logical topology. In another embodiment method, the plurality of virtual gateways is a plurality of virtual service specific serving gateways (v-s-SGWs). In an additional embodiment method, updating the data plane logical topology further includes moving a virtual function from a third virtual gateway of the plurality of virtual gateways to a fourth virtual gateway of the plurality of virtual gateways. Another embodiment method further includes determining the customer specific service parameters for a customer before updating the customer specific service parameters and defining the data plane logical topology before updating the data plane logical topology.

An embodiment method further includes receiving, by the SDT controller from a customer, the customer specific service parameters. For example, the customer specific service parameters include a service description, and updating the data plane logical topology further includes updating the data plane logical topology in accordance with the service description. In another example, the customer specific service parameters include a service requirement, and updating the data plane logical topology further includes updating the data plane logical topology in accordance with the service requirement. In an additional embodiment, the customer specific service parameters include an event definition, where updating the data plane logical topology further includes updating the data plane logical topology in accordance with the event definition. In another example, the customer specific service parameters include a reaction definition, and updating the data plane logical topology further includes updating the data plane logical topology in accordance with the reaction definition.

An embodiment method further including transmitting, by the SDT controller to a software defined protocol (SDP) controller, a logical function definition, where the data plane logical topology includes the logical function definition. Another embodiment method further including transmitting, by the SDT controller to a customer, the updated the data plane logical topology. An additional embodiment method further including transmitting, by the SDT controller to a software defined networking (SDN) controller, the updated the data plane logical topology. In another embodiment, the report indicates a network status or a cloud resource status. In an additional embodiment the report indicates a change in network traffic. Implementations of the described techniques may include hardware, a method or process, or computer software on a computer-accessible medium.

An embodiment software defined topology (SDT) controller includes a processor and a non-transitory computer readable storage medium storing programming for execution by the processor. The programming includes instructions to receive, from a first virtual gateway in a plurality of virtual gateways in a data plane, a report and update customer specific service parameters in accordance with the report. The programming also includes instructions to update a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

In another embodiment, the programming further includes instructions to receive, from a customer, the customer specific service parameters, where the customer specific service parameters include a service description, and where updating the data plane logical topology further includes updating the data plane logical topology in accordance with the service description. In an additional embodiment, the instructions further include instructions to transmit, to a customer, the updated the data plane logical topology. In another embodiment, adding the virtual gateway includes determining a location and capacity for an added virtual gateway in the data plane logical topology. Implementations of the described techniques may include hardware, a method or process, or computer software on a computer-accessible medium.

An embodiment computer program product includes a non-transitory computer readable storage medium storing programming for execution by the processor. The programming including instructions for receiving, by a software defined topology (SDT) controller from a first virtual gateway of a plurality of virtual gateways in a data plane, a report and updating customer specific service parameters in accordance with the report. The programming also includes instructions for updating a data plane logical topology of the data plane in accordance with the report, where updating the data plane logical topology includes at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method comprising:
receiving, by a software defined topology (SDT) controller from a first virtual gateway of a plurality of virtual gateways in a data plane, a report;
updating customer specific service parameters in accordance with the report; and
updating a data plane logical topology of the data plane in accordance with the report, wherein updating the data plane logical topology comprises at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

2. The method of claim 1, wherein adding the virtual gateway includes determining a location and capacity for an added virtual gateway in the data plane logical topology.

3. The method of claim 1, wherein the plurality of virtual gateways is a plurality of virtual service specific serving gateways (v-s-SGWs).

4. The method of claim 1, wherein updating the data plane logical topology further comprises moving a virtual function from a third virtual gateway of the plurality of virtual gateways to a fourth virtual gateway of the plurality of virtual gateways.

5. The method of claim 1, further comprising:
determining the customer specific service parameters for a customer before updating the customer specific service parameters; and
defining the data plane logical topology before updating the data plane logical topology.

6. The method of claim 1, further comprising receiving, by the SDT controller from a customer, the customer specific service parameters.

7. The method of claim 6, wherein the customer specific service parameters comprise a service description, and wherein updating the data plane logical topology further comprises updating the data plane logical topology in accordance with the service description.

8. The method of claim 6, wherein the customer specific service parameters comprise a service requirement, and wherein updating the data plane logical topology further comprises updating the data plane logical topology in accordance with the service requirement.

9. The method of claim 6, wherein the customer specific service parameters comprise an event definition, and wherein updating the data plane logical topology further comprises updating the data plane logical topology in accordance with the event definition.

10. The method of claim 6, wherein the customer specific service parameters comprise a reaction definition, and wherein updating the data plane logical topology further comprises updating the data plane logical topology in accordance with the reaction definition.

11. The method of claim 1, further comprising transmitting, by the SDT controller to a software defined protocol (SDP) controller, a logical function definition, wherein the data plane logical topology comprises the logical function definition.

12. The method of claim 1, further comprising transmitting, by the SDT controller to a customer, the updated the data plane logical topology.

13. The method of claim 1, further comprising transmitting, by the SDT controller to a software defined networking (SDN) controller, the updated the data plane logical topology.

14. The method of claim 1, wherein the report indicates a network status or a cloud resource status.

15. The method of claim 1, wherein the report indicates a change in network traffic.

16. A software defined topology (SDT) controller comprising:
a processor; and
a non-transitory computer readable storage medium storing programming for execution by the processor, the programming including instructions to
receive, from a first virtual gateway in a plurality of virtual gateways in a data plane, a report,
update customer specific service parameters in accordance with the report, and
update a data plane logical topology of the data plane in accordance with the report, wherein updating the data plane logical topology comprises at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.

17. The SDT controller of claim 16, wherein the programming further includes instructions to receive, from a customer, the customer specific service parameters, wherein the customer specific service parameters comprise a service description, and wherein updating the data plane logical topology further comprises updating the data plane logical topology in accordance with the service description.

18. The SDT controller of claim 16, wherein the instructions further comprise instructions to transmit, to a customer, the updated the data plane logical topology.

19. The SDT controller of claim 16, wherein adding the virtual gateway includes determining a location and capacity for an added virtual gateway in the data plane logical topology.

20. A computer program product comprises a non-transitory computer readable storage medium storing programming for execution by the processor, the programming including instructions for:
receiving, by a software defined topology (SDT) controller from a first virtual gateway of a plurality of virtual gateways in a data plane, a report;
updating customer specific service parameters in accordance with the report; and
updating a data plane logical topology of the data plane in accordance with the report, wherein updating the data plane logical topology comprises at least one of adding a virtual gateway to the plurality of virtual gateways, removing a virtual gateway of the plurality of virtual gateways, modifying a capacity of a virtual gateway of the plurality of virtual gateways, and modifying a location of a virtual gateway of the plurality of virtual gateways, to produce an updated data plane logical topology.
